(19) United States
(12) Patent Application Publication
(10) Pub. No.: US 2007/0124524 A1
(43) Pub. Date: May 31, 2007

(54) Paper tray with integrated computing accessory devices

(75) Inventors: David Michael Gawlowski, Bend, OR (US); Matthew William Gawlowski, Sunnyvale, CA (US)

Correspondence Address: Matt Gawlowski;Pressure Drop Inc., 19026 Choctaw Road, Bend, OR, 97702, US

(73) Assignee: Pressure Drop Inc., Bend, OR (US)

(21) Appl. No.: 11/291,417

(22) Filed: Nov. 30, 2005

(51) Int. Cl. G06F 13/00

(52) U.S. Cl. 710/300

(57) ABSTRACT

A paper tray with one or more integrated devices used to expand the functionality of a personal computer system (computer peripherals). Used to store paper and provide the desired additional functionality in an attractive enclosure that reduces clutter and the number of objects on a user's desk. One or more paper tray(s) may be horizontal or vertical or at an angle, and may contain one or more devices such as a universal serial bus (USB) hub, IEEE 1394 (FireWire) hub, external hard drive, or other computer peripherals.

### CROSS-REFERENCE TO RELATED APPLICATIONS

U.S. Pat. No. 4,809,141—2/1989 Leopoldi et al. 362/99
U.S. Pat. No. 6,050,849—4/2000 Chang 439/536
U.S. Pat. No. 6,275,375 B1—8/2001 Nam 361/682
U.S. Pat. No. 6,363,491 B1—3/2002 Endo 713/310
U.S. Pat. No. 6,449,142 B1 —9/2002 Wu 361/680
U.S. Pat. No. 6,669,513 B2—12/2003 Huang 439/638
U.S. Pat. No. 6,722,917 B2—4/2004 Huang 439/501
2002/0078274 A1—6/2002 Kutaragi et al. 710/62
2002/0171999 A1—11/2002 Huang 361/600
2003/0133263 A1—7/2003 Shu 361/685
2004/0033734 A1—2/2004 Lelong et al. 439/894

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

The present invention relates to office equipment and computer peripherals in general, and particularly to a paper tray with a built in Universal Serial Bus (hereinafter referred to as USB) hub and an IEEE 1394 (hereinafter referred to as FireWire) hub combined into one assembly.

A paper tray typically consists of one or more horizontal trays, or one or more vertical spaces, used to hold and organize one or more sheets of paper of various size and shape. Paper trays have been utilized in desktop applications for centuries and are a common accessory to an office workspace.

A more recent addition to an office workspace is the personal computer system (hereinafter referred to as a PC), which typically includes a computer, a display such as a CRT or flat panel display, input devices such as keyboards and mice, and other Computing Accessory Devices.

A Computing Accessory Device is a device designed to expand the functionality of a computing system. Examples of Computing Accessory Devices include, but are not limited to, a USB hub, a FireWire hub, a storage device (including, but not limited to solid state memory, magnetic storage, and optical storage), an illumination device (the purpose of which includes, but is not limited to, illuminating a workspace, conveying a message to a user, or providing visual entertainment), an audio speaker, a microphone, a video capture device, an ethernet switch or hub which follows the IEEE 802.3 standards, a removable media writer or reader, a wireless access point or hub which follows at least one of the IEEE standards, a modem, a printed circuit board designed to connect a computing system with another electronic device, a monitor stand, or a rigidly mounted connector for connecting a mobile electronic device such as a telephone or personal digital assistant.

In recent years the USB and FireWire interfaces have gained popularity as a simple, user-friendly way to connect a multitude of Computing Accessory Devices to a PC. Computer manufacturers typically provide a limited number of USB and/or FireWire connections, also called USB or FireWire ports, in a PC.

To provide for connecting to a greater number of devices, a cable connection is provided from the PC to a USB or FireWire hub, with the type of hub used depending on the type of Computing Accessory Device the user wishes to connect. Each hub converts a single attachment point (known as the upstream port) into multiple attachment points (known as downstream ports). Currently, hubs typically have from 2 to 7 downstream ports, allowing a user to connect an additional two to seven devices. In addition, a cable may connect from the hub to one or more additional hubs to provide an even greater number of connections. In this manner a user can expand the number of Computing Accessory Devices connected to a PC to 127 USB-based devices through the use of multiple USB hubs, or 63 FireWire-based devices through the use of multiple FireWire hubs. This approach has the disadvantage of requiring multiple power outlets, one for each hub, and results in multiple hubs and cables creating an undesirable and chaotic appearance.

Computing Accessory Devices typically contain an Electronics Enclosure, which is an assembly made up of one or more parts. The function of an Electronic Enclosure includes, but is not limited to, protecting Electronic Components from physical harm, protecting Electronic Components from electronic harm, limiting the amount of electromagnetic radiation that may radiate from the Electronic Components, limiting the amount of external electromagnetic radiation that may interfere with Electronic Components, and to improve the aesthetic qualities of Electronic Components. Electronic Components include, but are not limited to, printed circuit board assemblies, electrical cables, power supplies, and light emitting devices. An Electronics Enclosure may be made from a variety of materials, including, but not limited to, metal, plastic, glass, paper, ceramic, and may contain a mixture thereof.

The typical appearance of Computing Accessory Devices currently manufactured is one of a predominantly utilitarian nature, usually box or disc shaped, constructed from plastic and painted, and obviously computer-related. This is aesthetically undesirable in a working environment where the user desires a clean and organized workspace, and where style and appearance are important to the user.

In addition, as the user acquires more Computing Accessory Devices to plug into their hubs, they require more outlets for power adaptors, power strips to plug the outlets into, more cords to connect peripherals to hubs or the PC, and the workspace becomes progressively more chaotic and unappealing.

Hitherto, a USB hub, a FireWire hub, other Computing Accessory Devices, and a paper tray have been well known, but combining the various Computing Accessory Devices into one assembly encased in a functional paper tray to disguise the Computing Accessory Devices from casual view has not been known.

### BRIEF SUMMARY OF THE INVENTION

The present invention integrates one or more Computing Accessory Devices into a single enclosure, designed to appear as a typical paper tray to better integrate visually with an office's decor, consolidate multiple Computing Accessory Devices into one, and simplify and organize a workspace.

The invention relates, in one embodiment, to a paper tray with a USB hub and a FireWire hub on a shared printed circuit board (PCB), mounted in the rear of the bottom tray of a horizontal paper tray assembly. The two hubs, by combining into one device, utilize only one power adapter instead of two, reducing workspace clutter. All power, USB, and FireWire connections are located at the rear of the assembly in close proximity to one another, reducing clutter and chaos from wires previously run throughout a workspace. No indication to the user from the front, top, or sides is given that the device which appears to be a paper tray is really a multi-function Computing Accessory Device.

In another embodiment of the present invention, a USB hub, a FireWire hub, and an external hard drive are combined into a paper tray. Because an external hard drive typically is connected to a PC through a USB or FireWire connection, the hard drive can be wired directly to the PCB located inside the paper tray containing the hub circuits, eliminating the need for the user to purchase and plug in a separate cable. A user would be able to select, through a hardware or software switch, whether they wanted the hard drive to operate off the USB or FireWire hub circuits. The two hubs and external hard drive, by combining into one device, utilize only one power adapter instead of three, reducing workspace clutter. All power, USB, and FireWire connections are located at the rear of the assembly in close proximity to one another, reducing clutter and chaos from wires previously run throughout a workspace. No indication to the user from the front, top, or sides is given that the device which appears to be a paper tray is really a multi-function Computing Accessory Device.

In another embodiment of the present invention, a paper tray as described in the previous embodiments could be designed to function in a vertical orientation perpendicular to the surface the tray is placed upon.

In another embodiment of the present invention, a paper tray as described in the previous embodiments could be designed to function in an angled orientation with respect to the surface the tray is on, such as at a fifteen degree, thirty degree, forty-five degree, or any other angle.

In another embodiment of the present invention, the PCB and related components necessary for the device to function as a computer peripheral or accessory could be located underneath either the top or bottom trays, or be integrated into the trays hollowed out for this purpose, or in the top tray, or other locations.

In another embodiment of the present invention, a paper tray as described in the previous embodiments could be designed to contain any of a number of different Computing Accessory Devices.

These and other features and advantages of the present invention will be apparent from the accompanying drawings and from the detailed description that follow.

### BRIEF DESCRIPTION OF SEVERAL VIEWS OF THE DRAWING

The invention is further described by way of example with reference to the accompanying drawings wherein:

FIG. 1. is an elevated view of one embodiment of the present invention of a paper tray with integrated Computing Accessory Devices, in this illustrated case a USB hub and a FireWire hub;

FIG. 2. is an exploded view of one embodiment of the present invention of a paper tray with integrated Computing Accessory Devices, in this illustrated case a USB hub and a FireWire hub;

### DETAILED DESCRIPTION OF THE INVENTION

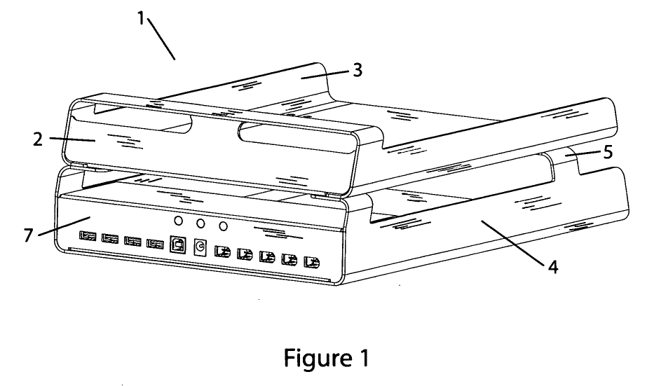

Referring to FIGS. 1 & 2, one embodiment of the invention, 1, is shown comprised of a top tray 2, a top tray siding and ornamental piece 3, a bottom tray 4 with integrated supports 5, a circuit board 6, an electronics enclosure 7, and supporting feet 8.

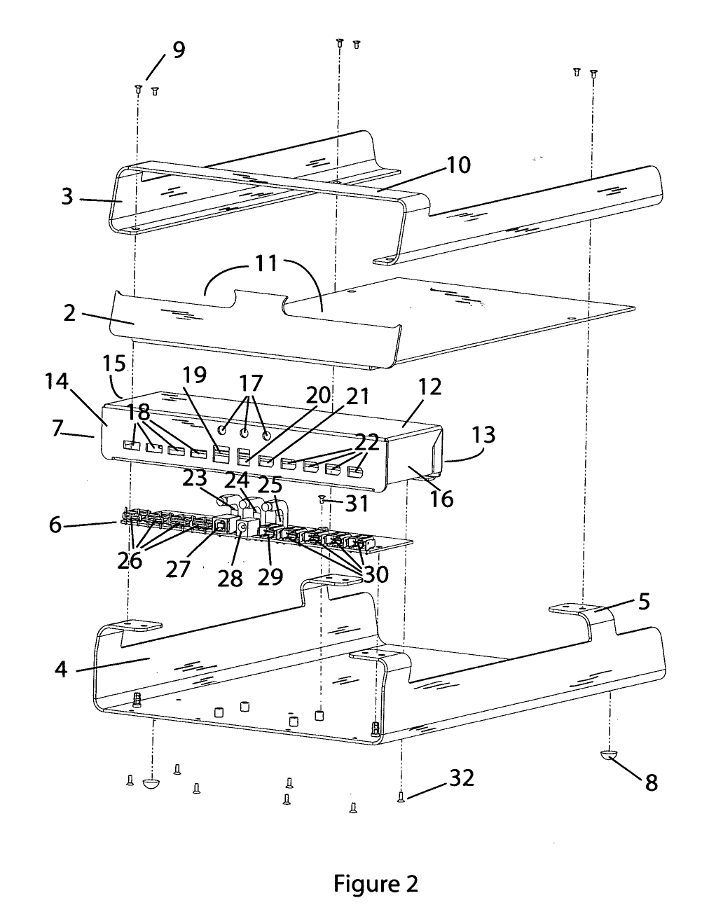

Referring to FIG. 2, the top tray section is comprised of two pieces, 2 and 3, which fit together and mount to the supports 5 built into the bottom tray 4, via screws 9. The top section features an ornamental band 10 which spans the width of the tray, and two ornamental gaps 11, in the rear portion of the top tray section.

Referring to FIG. 2, the bottom tray 4 is formed from a single piece for its bottom and two sidewalls, and makes use of the electronics enclosure 7 to form the rear of the tray.

Referring to FIG. 2, the electronics enclosure is comprised of a single piece of material folded to form a box with a top 12, a front 13, a back 14, and two sides 15 & 16. Holes 17, 18, 19, 20, 21 & 22 in the back 14 of the enclosure are formed to match and align with components mounted on the circuit board 6. In the illustrated current embodiment of circuit board 6, each of three LEDs, 23, 24, & 25, align with a hole 17, each of four USB downstream connectors 26 align with a hole 18, a USB upstream connector 27 aligns with hole 19, a power connector 28 aligns with hole 20, a FireWire connector 29 used as an upstream port is aligned with hole 21, and four FireWire connectors 30 used as downstream ports align with holes 22. Circuit board 6 is mounted to the bottom tray 4 via screws 31, and the electronics enclosure is mounted over and around the circuit board 6 to the bottom tray via screws 32.

What is claimed is:

1. A paper tray device, comprising:
one or more spaces, each intended to contain one or more pieces of paper oriented at a set angle with respect to the horizontal;
an Electronics Enclosure; and
one or more Computing Accessory Devices installed in the electronics enclosure.

2. A paper tray device as recited in claim 1, wherein the spaces intended to contain pieces of paper are oriented primarily parallel with respect to the surface the device sits on or is attached to.

3. A paper tray device as recited in claim 1, wherein the spaces intended to contain pieces of paper are oriented primarily perpendicular with respect to the surface the device sits on or is attached to.

4. A paper tray device as recited in claim 1, wherein multiple Computing Accessory Device functions are integrated into a single Computing Accessory Device.

5. A paper tray device as recited in claim 4, wherein the single Computing Accessory receives power primarily from a single external power source.

6. A paper tray device as recited in claim 1, wherein the Computing Accessory Devices are a USB hub and a FireWire hub.

7. A paper tray device as recited in claim 6, wherein the spaces intended to contain pieces of paper are in a horizontal orientation.

8. A paper tray device as recited in claim 1, wherein the Computing Accessory Device is a USB hub.

9. A paper tray device as recited in claim 1, wherein the Computing Accessory Device is a FireWire hub.

10. A paper tray device as recited in claim 1, wherein the Computing Accessory Device is a storage device (including, but not limited to solid state memory, magnetic storage, or optical storage).

11. A paper tray device as recited in claim 1, wherein the Computing Accessory Devices are a USB hub, a FireWire hub, and a storage device (including, but not limited to solid state memory, magnetic storage, or optical storage).

12. A paper tray device as recited in claim 1, wherein the Computing Accessory Devices are a USB hub, a FireWire hub, and a removable media writer and/or reader.
